(19) United States
(12) Patent Application Publication
(10) Pub. No.: US 2018/0146687 A1
(43) Pub. Date: May 31, 2018

(54) HUMMUS RAVIOLI

(71) Applicant: Ciara Schultz, Ballston Spa, NY (US)

(72) Inventor: Ciara Schultz, Ballston Spa, NY (US)

(21) Appl. No.: 15/364,513

(22) Filed: Nov. 30, 2016

(51) Int. Cl. A21D 13/00; A23L 19/00

(52) U.S. Cl. CPC A21D 13/0019; A23L 19/09

(57) ABSTRACT

A dumpling, particularly ravioli, containing an edible hummus-based food substance and a method of making the same are herein described. More specifically, dough for a ravioli, or similar dumpling, is prepared and cut into individual units for each of a set of ravioli. Each ravioli can have a top and a bottom piece of cut dough or sufficient dough to be folded over upon itself. For each ravioli, a hummus-based food substance, such as hummus or a food substance containing hummus, is placed on a cut piece of ravioli dough. A fully enclosed pocket of dough containing the hummus-based food substance is formed by affixing a top piece of dough over the hummus and a bottom piece of dough or by folding the dough over and affixing it to itself. This forms a sealed pocket of hummus in each ravioli. The ravioli can then be cooked and served.

### TECHNICAL FIELD

The present invention relates generally to an edible composition of food and, more specifically, to dumplings, particularly ravioli, filled with an edible hummus-based food substance and a method of making the same.

### BACKGROUND

As increasingly fast communications and ease of travel bring various cultures into contact, cultural traditions, including foods, become popular in places far removed from their places of origin. As a result, some restaurants and grocery stores specialize in particular ethnic or cultural dishes and cuisine as demand for foods from various culinary traditions grows. Moreover, chefs and others who make food have begun experimenting with combining elements from different culinary traditions in a movement commonly called “fusion cuisine.” Cuisines of this type are not categorized according to any one particular cuisine style and often play a part in innovations of many contemporary restaurant cuisines.

However, it can sometimes be difficult to find a way to combine culinary dishes from diverse cultures in a way that is appetizing and easy to consume while also preserving the cultural heritage, taste, and flavor of the original dishes. Accordingly, there is a need for food products that are easily added to a variety of dishes while providing a desirable comingling of tastes and flavors from the original culinary traditions.

### SUMMARY

An edible food item comprising a dumpling, particularly ravioli, containing an edible hummus-based food substance and a method of making the same are herein described. According to embodiments of the present invention, dough for a ravioli, or similar dumpling, is prepared and cut into individual units for each of a set of ravioli. Each ravioli can have a top piece and a bottom piece of cut dough or sufficient dough to be folded over upon itself. For each ravioli, a hummus-based food substance, such as hummus or a food substance containing hummus, is placed on a cut piece of ravioli dough. A fully enclosed pocket of dough containing the hummus-based food substance is formed by affixing a top piece of dough over the hummus and a bottom piece of dough or by folding the dough over and affixing it to itself. This forms a sealed pocket of hummus in each ravioli. The ravioli can then be cooked and served in a variety of dishes.

A first aspect of the present invention includes a hummus-filled dumpling prepared by a process comprising the steps of: making dough corresponding to a type of the dumpling; making a mixture comprising hummus; cutting the dough into a set of dough pieces corresponding to a set of dumplings; placing a portion of the mixture comprising hummus onto a dough piece of the set of dough pieces; and sealing the portion of the mixture comprising hummus inside the dough piece by covering the portion of the mixture comprising hummus with additional dough and pressing the additional dough against the dough piece.

Another aspect of the present invention includes a method for making hummus-filled dumplings comprising: making dough for a type of the dumplings and making hummus; cutting the dough into a plurality of dough pieces corresponding to each of the hummus-filled dumplings; placing a portion of the hummus onto a dough piece for each of the hummus-filled dumplings; and sealing the portion of hummus inside the dough piece by covering the portion of hummus with additional dough and pressing the additional dough against the dough piece.

Yet another aspect of the present invention includes a hummus-filled ravioli comprising: a first layer of dough; hummus disposed on a central, top portion of the first layer of dough; and a second layer of dough covering a top and sides of the hummus, the second layer of dough connecting with the first layer of dough in a perimeter around the hummus.

### BRIEF DESCRIPTION OF THE SEVERAL VIEWS OF THE DRAWINGS

These and other features of this invention will be more readily understood from the following detailed description of the various aspects of the invention taken in conjunction with the accompanying drawings in which:

FIG. 1 shows a method for making ravioli dough according to illustrative embodiments of the present invention;

FIG. 2 shows a method for making hummus according to illustrative embodiments of the present invention; and

FIG. 3 shows a method for making hummus-filled ravioli according to illustrative embodiments of the present invention.

The drawings are not necessarily to scale. The drawings are merely representations, not intended to portray specific parameters of the invention. The drawings are intended to depict only typical embodiments of the invention, and therefore should not be considered as limiting in scope. In the drawings, like numbering represents like elements.

### DETAILED DESCRIPTION

Illustrative embodiments will now be described more fully herein with reference to the accompanying drawings, in which illustrative embodiments are shown. It will be appreciated that this disclosure may be embodied in many different forms and should not be construed as limited to the illustrative embodiments set forth herein.

Furthermore, the terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. Furthermore, similar elements in different figures may be assigned similar element numbers. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

Hummus, also known as “hummus bi tahini,” is a Levantine and Egyptian food dip or spread made from cooked, mashed chickpeas or other beans, blended with tahini, olive oil, lemon juice, salt, and/or garlic. Today, it is popular throughout the Middle East, North Africa, and in Middle Eastern cuisine around the globe. In recent years, hummus has also become particularly popular in the United States and can be found in most grocery stores in North America.

The inventor of the present invention has found a way to combine hummus with a variety of dishes not traditionally associated with hummus by packaging the hummus in dough, and, more specifically, as a ravioli filled with hummus. As stated above, features of embodiments of the present invention include an edible food item comprising a dumpling, particularly ravioli, containing an edible hummus-based food substance and a method of making the same are herein described. According to embodiments of the present invention, dough for a ravioli, or similar dumpling, is prepared and cut into individual units for each of a set of ravioli. Each ravioli can have a top piece and a bottom piece of cut dough or sufficient dough to be folded over upon itself. For each ravioli, a hummus-based food substance, such as hummus or a food substance containing hummus, is placed on a cut piece of ravioli dough. A fully enclosed pocket of dough containing the hummus-based food substance is formed by affixing a top piece of dough over the hummus and a bottom piece of dough or by folding the dough over and affixing it to itself. This forms a sealed pocket of hummus in each ravioli. The ravioli can then be cooked and served in a variety of dishes.

It should be understood that embodiments of the present invention are not limited to ravioli. It is within the scope of the invention to package the hummus or hummus-based food substance in any type of dumpling, such as, for example, a pierogi or a potsticker.

Further, it should be understood that the term “dumpling” as used herein is intended to include any edible item of food that includes small pieces of dough (made from a variety of starch sources, such as bread, flour, potatoes, etc.) wrapped around a filling. Dumplings, which can be savory or sweet, can be cooked, for example, by baking, boiling, frying, simmering, or steaming them and can be eaten by themselves, with gravy or sauce, or in soups or stews.

Furthermore, it should be understood that the term “ravioli” as used herein is intended to indicate a type of dumpling composed of a filling sealed between two layers of thin pasta dough. Ravioli are typically square, although other forms are within the scope of the present invention, such as circular, semi-circular (e.g., mezzelune), and ring-shaped (e.g., tortellini or tortelloni).

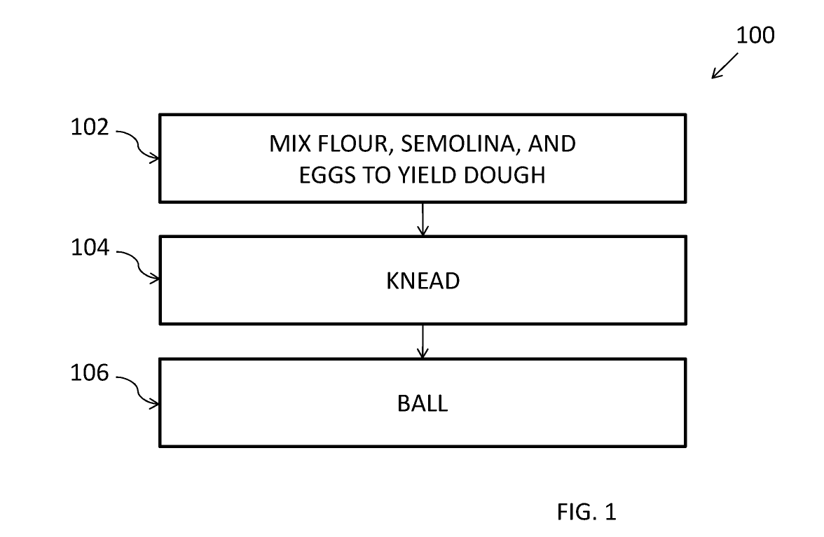

According to some embodiments of the present invention, dough for ravioli or dumplings can be made using any method, components, or ingredients now known or later developed to yield suitable dough with which to make ravioli or dumplings. For example, referring now to method 100 in FIG. 1, in one embodiment, pasta dough for ravioli can be made by mixing at 102 about eight (8) parts flour (e.g., Divella 00 flour) to about one (1) part semolina (e.g., durum wheat semolina) to one (1) egg per cup of flour. The dough can then be kneaded at 104 and formed into a ball at 106 in preparation for making ravioli or another type of dumpling. In still other embodiments, dough for dumplings can be made using any of the above components along with baking powder, sugar, salt, and/or butter or butter substitute.

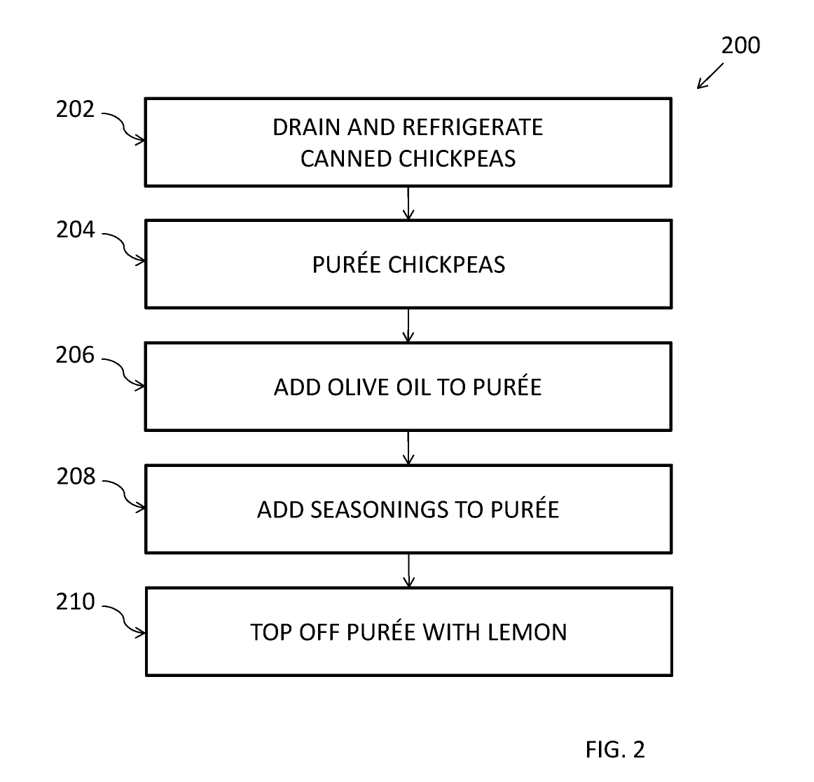

According to further embodiments of the present invention, hummus or a hummus-based food substance (e.g., hummus mixed with chopped vegetables or other fillers) can be made using any method, components, or ingredients now known or later developed to yield hummus. For example, referring now to method 200 in FIG. 2, in one embodiment, hummus can be made by mixing about thirty-six (36) parts canned chick peas to about six (6) parts fresh lemon to about three (3) garlic cloves (per 12 oz of chick peas) or about one (1) part garlic powder, plus tahini, pepper (e.g., white pepper), salt (e.g., sea salt), and/or oil (e.g., extra virgin olive oil) to taste. In this embodiment, the hummus can be made by draining and refrigerating the chickpeas at 202, and then puréeing (e.g., with a food processor) the chickpeas at 204. Oil can then be added to this purée at 206, followed by adding seasonings at 208 as needed, and topping off the puréed mixture with squeezed lemon juice at 210. It should be noted that this and all hummus mixtures can be made to taste and can contain variations and additional components. In further embodiments, hummus can include any flavoring or seasonings as desired.

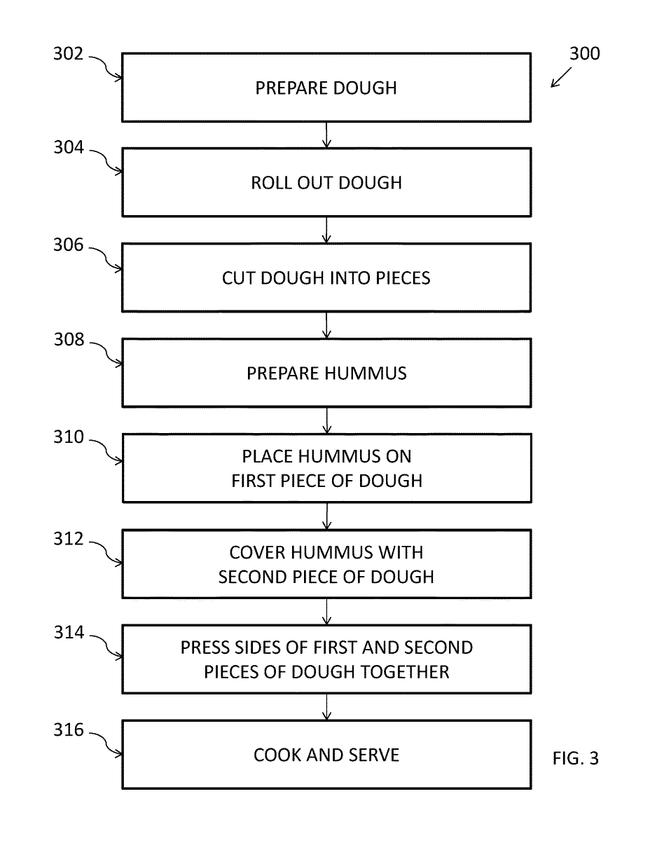

Referring now to FIG. 3, a method 300 of making hummus-filled ravioli according to embodiments of the present invention will be shown and described. At 302, dough for ravioli or another type of dumpling is prepared using method 100 described in FIG. 1 or by using any presently known or later discovered method and components to make ravioli or dumpling dough. At 304, the dough is rolled out or flattened to a thin consistency with a thickness sufficient for making ravioli or another type of dumpling. The dough is then be cut at 306 into individual pieces, such as top and bottom pieces for raviolis or fold-over pieces for other types of dumplings, and then set aside. The cut pieces can have any shape, such as squares or circles. At 308, hummus or a hummus-based food substance is prepared using method 200 described in FIG. 2 or by using any presently known or later discovered method and components to make hummus or a food substance containing hummus. According to embodiments of the present invention, about one to three (1-3) teaspoons of hummus or a hummus-based food substance is placed in about the middle of a (first) piece of dough for each ravioli at 310. The hummus is then covered with a second piece of dough or by folding the dough over onto itself at 312. The sides of the first and second pieces of dough or folded over piece of dough are pressed, crimped, or squeezed together at 314, forming a completed ravioli (or other type of dumpling) having a sealed pocket of hummus surrounded by dough. The completed ravioli of embodiments of the present invention can then be cooked (e.g., baked, boiled, fried, simmered, or steamed) and served as part of a dish at 316.

The hummus-filled ravioli or other type of dumpling of the present invention can be served in a variety of dishes in order to blend Levantine/Egyptian cuisine with other culinary traditions. For example, hummus-filled ravioli can be used to create dishes that blend Middle Eastern and Italian tastes and flavors. A hummus-filled pierogi can be used in an Eastern European style dishes to infuse the dish with a Levantine style flavor. And a hummus-filled potsticker can be introduced to Chinese or East Asian cuisine to blend East Asian and Middle Eastern tastes.

Process flowcharts of methods 100, 200, and 300 illustrate possible implementations of various embodiments of the present invention. In some alternative implementations, the steps noted in the blocks may occur out of the order noted in the Figures. For example, two blocks shown in succession may, in fact, be performed substantially concurrently, or the blocks may sometimes be performed in the reverse order. It will be understood that each block of the flowchart illustrations and/or block diagrams, and combinations of blocks in the flowchart illustrations and/or block diagrams, can be performed by a person or a machine programed to carry out methods of embodiments of the present invention.

It is apparent that there has been provided herein approaches for hummus-filled ravioli and methods for making the same. While the invention has been particularly shown and described in conjunction with exemplary embodiments, it will be appreciated that variations and modifications will occur to those skilled in the art. Therefore, it is to be understood that the appended claims are intended to cover all such modifications and changes that fall within the true spirit of the invention.

What is claimed is:

1. A hummus-filled dumpling prepared by a process comprising the steps of:
making dough corresponding to a type of the dumpling;
making a mixture comprising hummus;
cutting the dough into a set of dough pieces corresponding to a set of dumplings;
placing a portion of the mixture comprising hummus onto a dough piece of the set of dough pieces; and
sealing the portion of the mixture comprising hummus inside the dough piece by covering the portion of the mixture comprising hummus with additional dough and pressing the additional dough against the dough piece.

2. The hummus-filled dumpling of claim 1, the dough being made by a process comprising the steps of:
mixing flour, semolina, and eggs to form a dough mixture; and
kneading the dough mixture.

3. The hummus-filled dumpling of claim 2, the dough mixture having a ratio of about 8 parts flour to about 1 part semolina to 1 egg per cup of flour.

4. The hummus-filled dumpling of claim 1, the mixture comprising hummus being made by a process comprising the steps of:
puréeing chickpeas;
adding oil, seasoning, and lemon juice to the puréed chickpeas; and
mixing the oil, seasoning, and lemon juice into the puréed chickpeas.

5. The hummus-filled dumpling of claim 4, the mixture comprising hummus having a ratio of about 36 parts canned chick peas to about 6 parts lemon juice to about 1 part garlic powder or about 3 garlic cloves per 12 ounces of chickpeas.

6. The hummus-filled dumpling of claim 4, the seasoning comprising at least one seasoning selected from the group consisting of: garlic, garlic powder, tahini, pepper, and salt.

7. The hummus-filled dumpling of claim 1, the hummus-filled dumpling being a ravioli.

8. The hummus-filled dumpling of claim 7, the dough piece being a first dough piece and the additional dough being a second dough piece and the sealing comprising pressing edges of the second dough piece to edges of the first dough piece.

9. The hummus-filled dumpling of claim 1, the dough piece and the additional dough being a single dough piece and the sealing comprising pressing edges of the single dough piece against one another.

10. A method for making hummus-filled dumplings comprising:
making dough for a type of the dumplings and making hummus;
cutting the dough into a plurality of dough pieces corresponding to each of the hummus-filled dumplings;
placing a portion of the hummus onto a dough piece for each of the hummus-filled dumplings; and
sealing the portion of hummus inside the dough piece by covering the portion of hummus with additional dough and pressing the additional dough against the dough piece.

11. The method for making hummus-filled dumplings of claim 10, the making the dough comprising:
mixing flour, semolina, and eggs to form a dough mixture; and
kneading the dough mixture,
wherein, the dough mixture has a ratio of about 8 parts flour to about 1 part semolina to 1 egg per cup of flour.

12. The method for making hummus-filled dumplings of claim 10, the making the hummus comprising:
puréeing chickpeas;
adding oil, seasoning, and lemon juice to the puréed chickpeas; and
mixing the oil, seasoning, and lemon juice into the puréed chickpeas,
wherein the hummus has a ratio of about 36 parts canned chick peas to about 6 parts lemon juice to about 1 part garlic powder or about 3 garlic cloves per 12 ounces of chickpeas, and
wherein, the seasoning comprising at least one seasoning selected from the group consisting of: garlic, garlic powder, tahini, pepper, and salt.

13. The method for making hummus-filled dumplings of claim 10, the hummus-filled dumplings being ravioli.

14. The method for making hummus-filled dumplings of claim 13, the dough piece being a first dough piece and the additional dough being a second dough piece and the sealing comprising pressing edges of the second dough piece to edges of the first dough piece.

15. The method for making hummus-filled dumplings of claim 10, the dough piece and the additional dough being a single dough piece and the sealing comprising pressing edges of the single dough piece against one another.

16. A hummus-filled ravioli comprising:
a first layer of dough;
hummus disposed on a central, top portion of the first layer of dough; and
a second layer of dough covering a top and sides of the hummus, the second layer of dough connecting with the first layer of dough in a perimeter around the hummus.

17. The hummus-filled ravioli of claim 16, the first and second layers of dough comprising a mixture of flour, semolina, and eggs.

18. The hummus-filled ravioli of claim 16, the hummus comprising a puréed mixture of chickpeas, oil, lemon juice, and seasoning comprising at least one seasoning selected from the group consisting of: garlic, garlic powder, tahini, pepper, and salt.
